(19) United States
(12) Patent Application Publication
(10) Pub. No.: US 2024/0100765 A1
(43) Pub. Date: Mar. 28, 2024

(54) METHOD FOR PRODUCING A COMPONENT MADE OF A FIBER-REINFORCED PLASTIC

(71) Applicant: ZF Friedrichshafen AG, Friedrichshafen (DE)

(72) Inventors: Ingolf MÜLLER, Freimersheim (Pfalz) (DE); Holger BUBLIES, Osnabrück (DE); Andre STIEGLITZ, Osnabrück (DE)

(21) Appl. No.: 18/273,926

(22) PCT Filed: Dec. 9, 2021
(86) PCT No.: PCT/EP2021/085003

§ 371 Date: Jul. 24, 2023

(30) Foreign Application Priority Data
Jan. 28, 2021 (DE) 10 2021 200 771.6

(51) Int. Cl. B29C 53/80; B29C 53/84; B29C 70/56; B29C 70/86

(52) U.S. Cl. CPC B29C 53/8016; B29C 53/8041; B29C 53/84; B29C 70/56; B29C 70/86

(57) ABSTRACT

A method for producing a structural component part (1, 33) from a fiber-reinforced plastic according to a three-dimensional winding process. A threadlike fiber material (12) is supplied on at least one bobbin (18) and constructed as a towpreg semifinished product is wound around at least one filament carrier (11) in a winding pattern by a computer-controlled winding device. The towpreg semifinished product is a mixture (30) of a thermoset resin, a hardener, an accelerator and plastic fibers (29) embedded in the mixture (30). The fiber material (12) is guided on the filament carrier (11) by a guide element (24) having a circular outlet cross section and arranged at a fiber guide device (25), the fiber material (12) deflected by the guide element (24) when the winding pattern is formed. The fiber material (12) is brought in contact with the guide element (24) during a deflection.

### PRIORITY CLAIM

This is a U.S. national stage of application No. PCT/EP2021/085003, filed on Dec. 9, 2021. Priority is claimed on German Application No. 10 2021 200 771.6, filed Jan. 28, 2021, the content of which is incorporated herein by reference.

### BACKGROUND OF THE INVENTION

The invention is directed to a method for producing a structural component part from a fiber-reinforced plastic in accordance with the preamble of claim 1. The invention is further directed to a device for producing a structural component part from a fiber-reinforced plastic in accordance with the preamble of claim 9. The invention is further directed to a fiber-reinforced structural component part according to claim 16.

Fiber-reinforced structural component parts are used in connection with lightweight designs for substituting structural component parts made from a metal with lighter-weight structural component parts. In order to have at least the same strength properties, fiber-reinforced plastics are used. Fiber-reinforced plastics are made from plastic fibers which are embedded in a matrix of a synthetic resin. Such structural component parts are produced by means of a three-dimensional winding process which is implemented by a computer-controlled winding machine. In order to achieve the highest possible winding speeds, a towpreg semifinished product is used which is characterized by a winding speed which is up to ten times faster compared to conventional wet winding methods. A further advantage of the towpreg semifinished product, i.e., plastic fibers which are pre-impregnated with a thermoset resin, consists in its tackiness in the incompletely cured state, which allows a greater diversity for laying down on a filament carrier. This greater lay-down diversity allows a wide variety of different winding patterns, particularly winding patterns deviating from geodesic lines.

A method and a device of the kind mentioned above are known from DE 10 2016 012 594 A1. The device for producing a structural component part from a fiber-reinforced plastic comprises a computer-controlled winding device for winding a threadlike fiber material supplied on at least one bobbin around at least one filament carrier in at least one winding pattern. The fiber material is formed as a towpreg semifinished product comprising a mixture of a thermoset resin, at least one hardener, at least one accelerator and plastic fibers embedded in the mixture.

A guide element having a substantially circular outlet cross section is arranged at a fiber guide device for guiding and deflecting the fiber material while the winding pattern is formed. The fiber material temporarily comes in contact with the guide element again and again during deflection. The fiber material can be damaged as a result of the deflections by the guide element, which can have consequences for the mechanical properties of the structural component part to be produced. The guide element influences not only the quality of the utilized towpreg semifinished product but also the preservation of the mechanical properties of the towpreg semifinished product. Thus, in the course of the winding processes, the surface of the guide element may become worn, for example, scored or grooved, particularly on one side. In this way, the fiber material can be damaged during the winding process, which can be traced back to sharp-edged areas on the surface of the guide element caused by wear.

Based on the prior art described above, an object of the present invention is to provide a method and a device for producing a structural component part from a fiber-reinforced plastic which avoids or at least mitigates the disadvantages known from the prior art.

### SUMMARY OF THE INVENTION

According to a disclosed embodiment, a method is suggested for producing a structural component part from a fiber-reinforced plastic according to a three-dimensional winding process. A threadlike fiber material which is supplied on at least one bobbin and is constructed as a towpreg semifinished product is wound around at least one filament carrier in at least one winding pattern by means of at least one computer-controlled winding device. The towpreg semifinished product comprises a mixture of thermoset resin, at least one hardener, at least one accelerator and plastic fibers embedded in the mixture. The fiber material is guided on the filament carrier by a guide element which has a substantially circular outlet cross section and which is arranged at a fiber guide device, and the fiber material is deflected by the guide element when the winding pattern is formed. The fiber material is temporarily brought in contact with the guide element during a deflection. According to a disclosed embodiment, it is provided that the proportions of hardener and accelerator in the thermoset resin are selected such that a temporary liquefaction of the thermoset resin occurs because of a friction heat generated on the surface of the fiber material through a deflection of the fiber material and/or by means of additional heat input in the area of contact with the guide element. By “accelerator” is meant a highly reactive hardener which accelerates the reaction time of the resin/hardener mixture during curing. The gelling time/hardening time can be adjusted by varying the quantity of the added accelerator. A further constituent of the mixture can be at least one additive, for example, a flow agent. In the uncured towpreg semifinished product, the thermoset resin is in a gel state in the mixture. In this gel state, the thermoset resin has highly viscous characteristics at room temperature. As a result of increasing ambient temperature, the thermoset resin liquefies and the viscosity decreases as the temperature increases. By varying the proportions of hardener and accelerator added to the thermoset resin, this temperature dependency can be adjusted in such a way that a temporary partial liquefaction of the thermoset resin of the fiber material is brought about in the area of contact with the guide element by means of the friction heat generated by the deflection of the fiber material and by the accompanying increase in temperature such that a slip layer is formed on the surface of the towpreg semifinished product. During deflection, the towpreg semifinished product slips over an expressly formed liquid layer. In this way, the towpreg semifinished product is protected against mechanical damage resulting from the deflection or from the filament guide device.

The proportions of hardener and accelerator in the thermoset resin can preferably be selected in such a way that a temporary liquefaction only results once a deflection exceeds 90°.

In particular, by selecting the proportions of hardener and accelerator, the liquefaction at the surface of the fiber material can be limited substantially to the duration of contact between the fiber material and the guide element during a deflection. The time period of the liquefaction should be as short as possible so as not to influence the properties of the fiber material, particularly its tackiness, when laying down on the filament carrier.

According to a preferred further development, heat can be additionally supplied to the fiber material during a deflection by the guide element. This may be necessary if the friction heat generated by deflection does not suffice to bring about the temporary liquefaction to form the slip film in sufficient quantities. Such a situation may arise, for instance, at the beginning of a winding process when the guide element is only at ambient temperature.

A stream of hot air can be provided in the region of deflection at the guide element for supplying heat. In particular, the airstream is supplied in a temporally limited manner directed on a narrowly limited localized area. A narrowly limited localized area is the contact surface of the fiber material contacting the guide element during a deflection. An external heat source in the form of a hot air blower can be used for this purpose. The flow of air can exit from a nozzle in order to achieve a local limiting of the heat.

Alternatively, a heat source can be integrated in the guide element for supplying heat. This has the advantage that it allows a more precise regulation of temperature.

In particular, the composition of the mixture of thermoset resin, at least one hardener and at least one accelerator is selected in such a way that the thermoset resin is in a gel state at ambient temperature prior to contact with the guide element and after the passage of the guide element.

Epoxy resin, vinyl ester resin, polyurethane resin or polyester resin can preferably be used as thermoset resin.

A device is also disclosed for producing a structural component part from a fiber-reinforced plastic according to a three-dimensional winding process. The device comprises at least one computer-controlled winding device for winding threadlike fiber material in at least one winding pattern around at least one filament carrier, which threadlike fiber material is supplied on at least one bobbin and is constructed as a towpreg semifinished product. The towpreg semifinished product comprises a mixture of a thermoset resin, at least one hardener, at least one accelerator and plastic fibers embedded in the mixture. A guide element having a substantially circular outlet cross section is arranged at a fiber guide device for guiding and deflecting the fiber material during the formation of the winding pattern. The fiber material can be brought into contact with the guide element temporarily during a deflection. The proportions of hardener and accelerator in the thermoset resin are selected in such a way that a temporary liquefaction of the thermoset resin occurs because of a friction heat generated on the surface of the fiber material as a result of a deflection of the fiber material and/or by means of the additional introduction of heat in the region of contact with the guide element. Reference is made to all of the statements referring to the suggested method for producing a structural component part from a fiber-reinforced plastic.

The guide element can preferably be made from a metal, a plastic or a ceramic. At least one guide element made from a metal has a surface coating in order to ensure specific slipping properties of the guide element.

According to a preferred embodiment, an external heat source controlled by a control device of the winding device in a temperature-dependent manner can be associated with the guide element. This may be necessary if the friction heat generated by the deflection does not suffice to bring about the temporary liquefaction to form the slip film in sufficient quantities. Such a situation may arise, for instance, at the beginning of a winding process when the guide element is only at ambient temperature. A preheating of the guide element can also be brought about prior to the start of the winding process by means of the external heat source. A temperature measuring device operating in a contactless manner can be provided for temperature monitoring. The temperature measuring device can be constructed as an infrared thermometer which preferably operates in the middle infrared wavelength range.

Additionally, the control device can be adapted to control the external heat source depending on the deflection angle of the fiber material. Accordingly, an additional temporary heat supply can be carried out, for example, only when a deflection angle, preferably greater than 90°, which can be predetermined and stored in the control device is exceeded. This has the advantage that the time when deflections take place and the deflection angle under which they take place are known based on the winding pattern for forming the structural component part, this winding pattern being deposited in the control device.

A heat source can preferably be integrated in the guide element. This saves installation space in particular and does not lead to a limiting of the required movement sequences of the winding device for executing the three-dimensional winding process.

For this purpose, the heat source integrated in the guide element can be constructed as a resistance heater. This is contemplated in a guide element made of metal. It is advantageous that this does not increase the installation space requirement for the guide element.

The invention is not limited to the indicated combination of features of the independent claims or the claims depending on the latter. Further, it is also possible to combine individual features as far as they arise from the claims, the following description of preferred embodiment forms of the invention or directly from the drawings. When the claims refer to the drawings through the use of reference numerals, this is not intended to limit the protective scope of the claims.

### BRIEF DESCRIPTION OF THE DRAWINGS

Advantageous embodiments of the invention which are described in the following are shown in the drawings. The drawings show:

FIGS. 1a-1e schematic views of fiber-reinforced structural component parts constructed as multipoint links;

FIG. 2 a schematic diagram of a device for fabricating fiber-reinforced structural component parts according to a three-dimensional winding method;

FIGS. 3A, 3B a schematic side view and top view of a guide element of a winding device;

FIG. 4 a greatly enlarged schematic view of a fiber material in cross section;

FIG. 5 a greatly enlarged schematic view of the fiber material according to FIG. 4 during introduction of heat; and

FIG. 6 a schematic view of a structural component part which is to be wrapped and which is constructed as a four-point link, a guide element and an external heat source.

### DETAILED DESCRIPTION OF THE PRESENTLY PREFERRED EMBODIMENTS

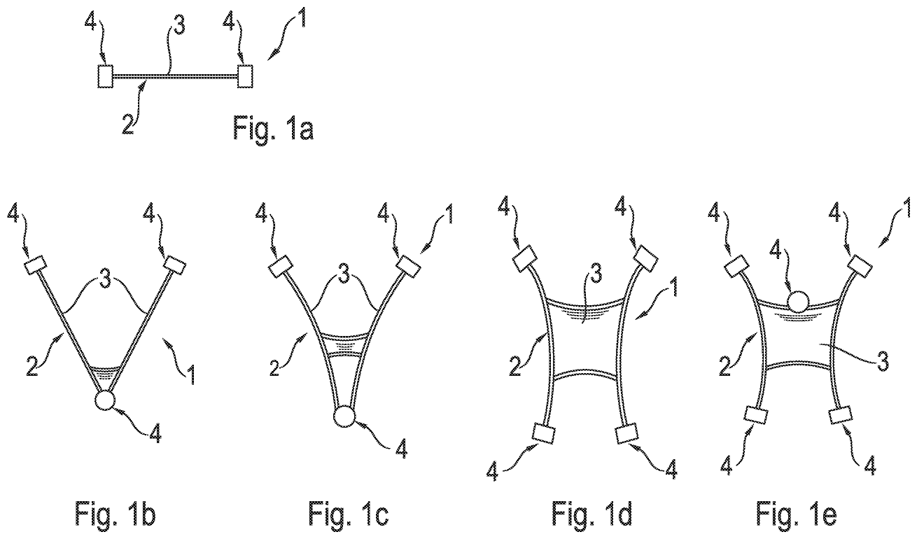

FIGS. 1a to 1e show schematic views of fiber-reinforced structural component parts 1 constructed as multipoint links. FIG. 1a shows a structural component part 1 of a chassis of a passenger vehicle or utility vehicle constructed as a two-point link. The structural component part 1 comprises a body 2 having at least two load introduction regions 4 which are connected to one another through a connection structure 3. In particular, the connection structure 3 of the body 2 can be constructed as a hollow profile. The body 2 substantially determines the basic shape of the structural component part 1. FIGS. 1b and 1c show two exemplary variants of a structural component part 1 formed as a three-point link. FIGS. 1d and 1e show an exemplary structural component part 1 formed as a four-point link or five-point link. Structural component parts 1 constructed as multipoint links can connect kinematic points in a chassis and/or in a wheel suspension and transmit motion and/or forces. The connection of the multipoint link to further component parts of the chassis can be realized by means of joints which are arranged in the load introduction regions 4. Owing to the symmetry of their shape and the arrangement of the load introduction regions 4, these structural component parts 1 have a definite, substantially constant load flow which is limited to a few dominant load directions. The fabrication of such structural component parts 1 as fiber-reinforced structural component parts by means of a three-dimensional winding process makes it possible to produce functional structural component parts which have a very small mass and, at the same time, high strength values and stiffness values.

An embodiment form of a device 10 for fabricating such fiber-reinforced structural component parts 1 according to a three-dimensional winding process and a method for producing a structural component part 1 from a fiber-reinforced plastic according to a three-dimensional winding process are described in the following. By means of at least one computer-controlled winding device 19, a threadlike fiber material 12 which is supplied on at least one bobbin 18 and is constructed as a towpreg semifinished product is wound around at least one filament carrier 11 with at least one winding pattern.

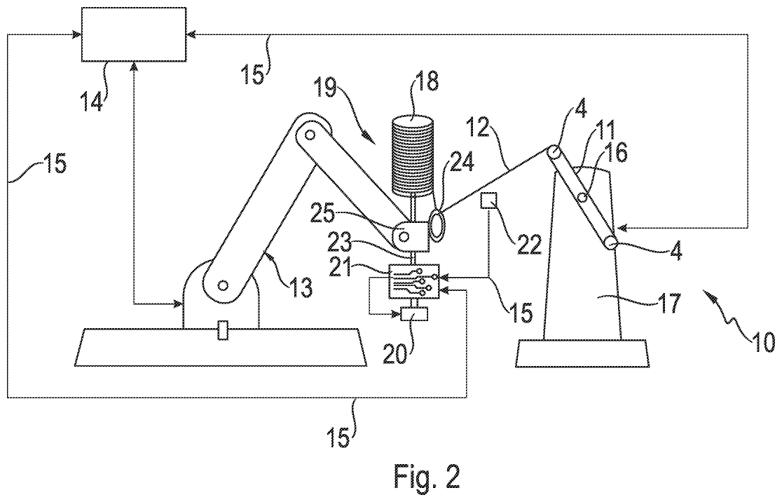

FIG. 2 schematically shows the device 10 for producing a fiber-reinforced structural component part 1 from a fiber-reinforced plastic according to a three-dimensional winding process. The device 10 comprises at least one computer-controlled winding device 19 for winding a threadlike fiber material 12 supplied on at least one bobbin 18 around at least one filament carrier 11. The filament carrier 11 forms a core element of the structural component part 1 which substantially determines the principle contour of the structural component part 1 to be produced in the three-dimensional winding process but without exercising a supporting function. The schematic view in FIG. 2 shows the filament carrier 11 with joint elements already arranged thereon in the load introduction regions 4. The fiber material 12 is laid down in the form of a winding pattern or a plurality of different winding patterns, each winding pattern being assigned a determined task for influencing one or more mechanical properties of the structural component part 1.

In this instance, the winding device 19 is preferably constructed as at least one robot arm 13 having six axes of rotation. A control device 14 which communicates with the robot arm 13 through a signal line or a bus system 15 is provided for controlling the at least one robot arm 13. The filament carrier 11 on which the at least one fiber strand 12 is wound in at least one winding pattern which can be preset by the control device 14 is arranged on a driven pivot shaft 16 of a pivot mounting 17. The driving of the pivot shaft 16 can likewise be controlled by the control device 14 via the bus system 15. The pivot shaft 16 of the pivot mounting 17 forms a seventh axis of rotation of the device 10. The substantially threadlike fiber material 12 is provided on the at least one bobbin 18. The bobbin 18 is arranged on the head of the robot arm 13 which forms a fiber guide device 25 and is guided along by this fiber guide device 25. The bobbin 18 can also be arranged spatially distant from the robot arm 13.

The device 10 further comprises at least one mechanism for maintaining a presettable fiber strand tension. The respective mechanism comprises a drive motor 20 which is constructed in particular as an electronically controlled synchronous motor, a computing unit 21 and at least one sensor unit 22 for detecting the fiber strand tension. The bobbin 18 is arranged on a spindle 23 so as to be fixed with respect to rotation relative to it, this spindle 23 being driven by the drive motor 20. The fiber material 12 taken off from the bobbin 18 is guided through a guide element which is arranged at the fiber guide device 25 and which has a substantially circular outlet cross section, and the fiber material 12 is laid down on or wound around the filament carrier 11.

In order to monitor the fiber strand tension, at least one sensor unit 22 can be arranged along the free path of the at least one fiber material 12 between the takeoff point on the bobbin 18 and the laydown point on the filament carrier 11.

The fiber material 12 is deflected by the guide element 24 as the winding pattern is formed on the filament carrier 11. The fiber material 12 is temporarily brought in contact with the guide element 24 during a deflection.

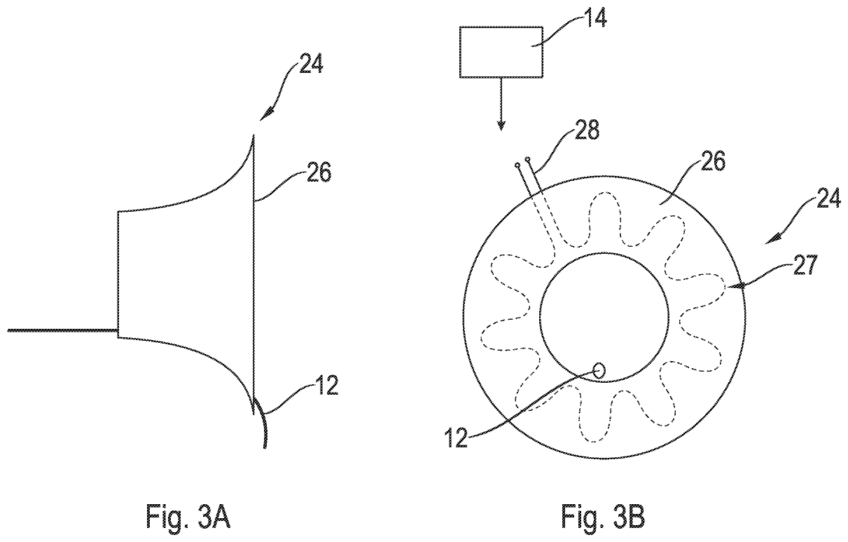

FIG. 3A shows a schematic side view of the guide element 24 of the winding device 19. FIG. 3B shows a schematic top view of the guide element 24 of the winding device 19. The guide element 24 has a funnel-shaped cross section which widens radially toward the outlet side 26 on which the fiber material 12 exits from the guide element 24. The guide element 24 is made from a metal, a plastic or a ceramic. At least one guide element 24 made from metal has a surface coating in order to ensure specific slip properties of the guide element 24 while the fiber material 12 is guided and deflected.

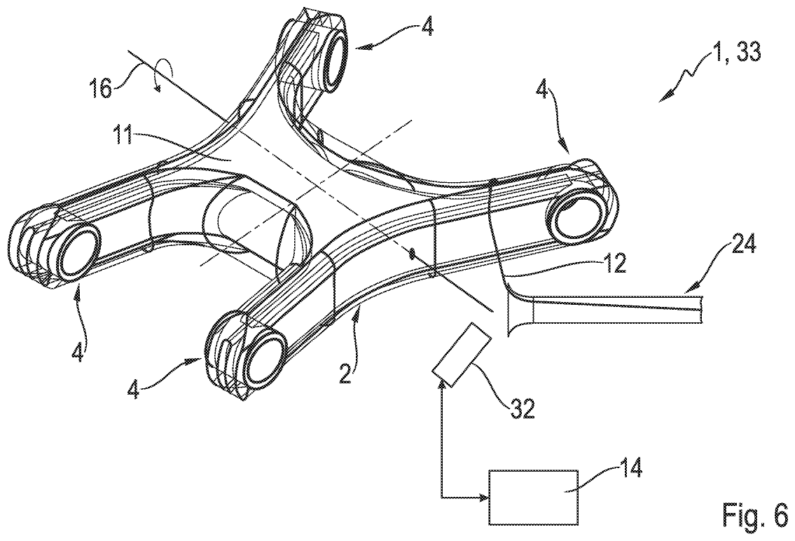

A heat source 27 can be integrated in the guide element 24 for additional heat input as indicated by way of example in FIG. 3B. The integrated heat source 27 is constructed as a resistance heating device 28. The integrated heat source 27 can be controlled by the control device 14 in order to selectively switch the heat source 27 on and off. The heat source 27 can also be constructed as an external heat source 32, for example, as a hot air blower as is shown by way of example in FIG. 6.

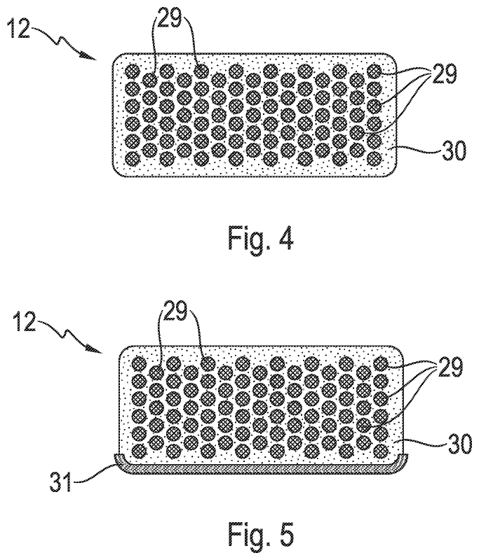

A greatly enlarged view of the fiber material 12 is shown schematically in cross section in FIG. 4. The threadlike fiber material 12 which is supplied on the bobbin 18 and is constructed as a towpreg semifinished product comprises a mixture 30 of a thermoset resin, at least one hardener, at least one accelerator and plastic fibers 29 embedded in the mixture 30. Further, the mixture can contain at least one additive. Polyvalent amines or aliphatic amines are used as hardener. The mixture 30 with aliphatic amines as hardener can set already at room temperature—so-called cold setting. The use of aromatic amines as hardener requires hot setting, as it is called, i.e., a supply of heat to implement curing in a temperature range above room temperature. The temperature required for curing is determined based on the hardener being used. A highly reactive hardener is known as an accelerator. When mixed in, it accelerates the reaction time of the resin/hardener mixture during curing. The thermoset resin is in the gel state in the mixture 30 in the uncured towpreg semifinished product. In this gel state, the thermoset resin has highly viscous characteristics at room temperature.

A highly enlarged view of the fiber material 12 according to FIG. 4 is shown schematically in FIG. 5 during exposure to heat. The heat is introduced by means of friction heat which is brought about during the deflection of the fiber material 12 through the guide element 24 as is indicated by way of example in FIG. 3A. Additionally or alternatively, heat can be introduced through the heat source 27.

A temporary liquefaction of the thermoset resin of the fiber material occurs because of the friction heat generated at the surface of the fiber material 12 by the deflection of the fiber material 12 in the area of contact with the guide element 24. A liquid layer 31 or slip layer is formed in the area of contact with the surface of the guide element 24 as a result of the temporary liquefaction of the thermoset resin, so that the mechanical loading of the fiber material 12 during deflection is reduced during sharp deflections, particularly deflections with a deflection angle in excess of 90°. This temporary liquefaction is achieved through the composition of the mixture 30, wherein the proportions of hardener and accelerator in the thermoset resin are selected such that the temporary liquefaction of the thermoset resin only occurs when a specific deflection angle is reached or exceeded.

By means of a suitable selection of the proportions of hardener and accelerator, the liquefaction at the surface of the fiber material 12 is substantially limited to the duration of contact between the fiber material 12 and guide element 24 during a deflection. This ensures the tackiness of the fiber material 12 required for maintaining specific winding patterns while the fiber material 12 is laid down on the filament carrier 11. In addition, material losses resulting from dripping resin can be avoided. The selection of the proportions of hardener and accelerator in the composition of the mixture 30 causes the thermoset resin to be in a gel state at ambient temperature before coming in contact with the guide element 24 and after the passage of the guide element 24.

Epoxy resin, vinyl ester resin, polyurethane resin or polyester resin is preferably used as thermoset resin.

FIG. 6 shows a schematic view of the structural component part 1 to be wrapped which is constructed at a four-point link 33 and the guide element 24 and an external heat source 32. The external heat source 32 is associated with guide element 24. For this reason, the external heat source 32 is arranged at the guide device 25 in a manner not shown in more detail. The external heat source 32 can preferably be controlled by the control device 14. A stream of heated air can be supplied in the area of deflection at the guide element 24 by means of the external heat source 32. The control device 14 can be adapted to control the external heat source 32 in a temperature-dependent manner. The control device 14 can be adapted to control the external heat source 32 depending on the deflection angle of the fiber material 12.

1. A method for producing a structural component part from a fiber-reinforced plastic according to a three-dimensional winding process, wherein a threadlike fiber material which is supplied on at least one bobbin and is constructed as a towpreg semifinished product is wound around at least one filament carrier in at least one winding pattern by means of at least one computer-controlled winding device, wherein the towpreg semifinished product comprises a mixture of a thermoset resin, at least one hardener, at least one accelerator, and plastic fibers embedded in the mixture, the fiber material is guided on the filament carrier by a guide element which has a substantially circular outlet cross section and which is arranged at a fiber guide device, and the fiber material is deflected by the guide element when the winding pattern is formed, wherein the fiber material is temporarily brought in contact with the guide element during a deflection, and wherein the proportions of hardener and accelerator in the thermoset resin are selected such that a temporary liquefaction of the thermoset resin occurs because of a friction heat generated on the surface of the fiber material through a deflection of the fiber material and/or by means of additional heat input in the area of contact with the guide element.

2. The method according to claim 1, wherein the proportions of hardener and accelerator in the thermoset resin are selected in such a way that a temporary liquefaction results once a deflection exceeds 90°.

3. The method according to claim 1, wherein the liquefaction at the surface of the fiber material is limited substantially to the duration of contact between the fiber material and the guide element during a deflection through the selection of the proportions of hardener and accelerator.

4. The method according to claim 1, wherein heat can be additionally supplied to the fiber material during a deflection by means of the guide element.

5. The method according to claim 4, wherein a stream of heated air is supplied in the region of the deflection at the guide element for supplying heat.

6. The method according to claim 4, wherein a heat source is integrated in the guide element for supplying heat.

7. The method according to claim 1, wherein the thermoset resin is in a gel state at ambient temperature prior to contact with the guide element and after the passage of the guide element.

8. The method according to claim 1, wherein one of epoxy resin, vinyl ester resin, polyurethane resin and polyester resin is used as thermoset resin.

9. A device for producing a structural component part from a fiber-reinforced plastic according to a three-dimensional winding process, comprising at least one computer-controlled winding device for winding a threadlike fiber material in at least one winding pattern around at least one filament carrier, which threadlike fiber material is supplied on at least one bobbin and is constructed as a towpreg semifinished product, wherein the towpreg semifinished product comprises a mixture of a thermoset resin, at least one hardener, at least one accelerator and plastic fibers embedded therein, wherein a guide element having a substantially circular outlet cross section is arranged at a fiber guide device for guiding and deflecting the fiber material during the formation of the winding pattern, wherein the fiber material can be brought into contact with the guide element temporarily during a deflection, and wherein the proportions of hardener and accelerator in the thermoset resin are selected in such a way that a temporary liquefaction of the thermoset resin occurs because of a friction heat generated on the surface of the fiber material as a result of a deflection of the fiber material and/or by means of the additional introduction of heat in the region of contact with the guide element.

10. The device according to claim 9, wherein the guide element is made from a metal, a plastic or a ceramic.

11. The device according to claim 9, wherein an external heat source controlled by a control device of the winding device in a temperature-dependent manner is associated with the guide element.

12. The device according to claim 11, wherein the control device is adapted to control the external heat source depending on the deflection angle of the fiber material.

13. The device according to claims 9, wherein a heat source is integrated in the guide element.

14. The device according to claim 13, wherein the heat source integrated in the guide element is constructed as a resistance heater.

15. The device according to claims 9, wherein the at least one filament carrier is arranged on a pivot shaft.

16. A structural component part made from a fiber-reinforced plastic which is produced according to claim 1, wherein the structural component part is constructed as a chassis component.
